(19) United States
(12) Patent Application Publication
(10) Pub. No.: US 2009/0061993 A1
(43) Pub. Date: Mar. 5, 2009

(54) MACHINE FOR PROVIDING AND CONTROLLING GAME

(76) Inventor: Yoshinari FUJIMOTO, Tokyo (JP)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/197,419

(22) Filed: Aug. 25, 2008

(30) Foreign Application Priority Data
Aug. 29, 2007 (JP) 2007-222071

(51) Int. Cl. A63F 9/24; A63F 13/12

(52) U.S. Cl. 463/25; 463/42

(57) ABSTRACT

A machine for providing and controlling game has a file for storing items which can be obtained by points, means for executing a procedure for obtaining according to an item purchase request, means for storing owned money of each player, means for producing selling exhibition information of the item, means for judging whether or not a purchase condition of each player meets a selling condition, means for deleting the item which was obtained by the player who sent the selling request and for storing such an item as the item of the player who sent the purchase request, and means for adding the selling money to the owned money of the player who sent the selling request and for subtracting from the owned money of the player who sent the purchase request.

### TECHNICAL FIELD

The invention relates to a machine for providing and controlling game through which item transaction can be actualized by exchange of money.

### BACKGROUND ART

Conventional entertainments, such as games, are formed on the basis of such a business model that a provider of an entertainment service receives monetary compensation, and by doing so an entertainment service is provided to a player. Therefore, in such a business model, it is inevitable that only players one-sidedly expense money. On the contrary, there are games, such as casinos, in which players have chances of obtaining money. But, in order to form such a game as business, it is necessary for a provider of such a game to always set an expected value of player's victory as minus, and as the result, it is necessary for players to expense money.

And, players sometimes exchange results by games each other, and often exchange money for the results. By the business model in which such an exchange between players is combined in game management, players can obtain monetary benefits.

Japanese patent application publication No. 2003-71140 is already known as a game system using money which is different from the above-mentioned business model.

### DISCLOSURE OF INVENTION

### Problems to be Solved by Invention

If we try to apply the above-mentioned business model to a on-line game, but, an transaction lacks credibility since it is not possible to perceive a trading partner. For this reason, an attempt for raising trading credibility for a network system is desired.

The invention has been made, having an eye to such a conventional theme, and an object of the invention is to provide a machine for providing and controlling game in order to construct item transaction with money exchange having high credibility.

### Means for Solving Problem

One aspect of the invention is a machine for providing and controlling game (102) with which two or more user terminals (103, 104) can be connected through the Internet (100), a game provided from said machine can be executed by a player through said user terminal (103, 104) so as to obtain points as the result of execution of said game and to store said obtained points therein, comprising:
point receiving means (112) for receiving through said Internet (100) a value of a point which said player obtained by an execution of said game, which is sent from said user terminal;
point storing means (112, 241, Step P1) for accumulating and storing said received value of point for each said player;
an item file (24, 115) for storing items (such as merchandise coupons and avatar items) which said player can obtain by said point and point numbers necessary for such an exchange in advance;
purchase request receiving means (115) for receiving through said Internet (100) an item purchase request (Step V8) for each said player which is sent from said user terminal;
item obtaining and storing means (115, Steps P2 to P5) for executing a predetermined obtaining processing on the basis of said point stored in said point storing means (112, 241) for said item stored in said item file according to said received item purchase request and for storing said obtained item for each said player;
owned money storing means (115, 241) for storing owned amount of money which each player has, which is usable in a game world every each said player;
selling request receiving means (115) for receiving through said Internet (100) selling request (Step A101, A103) of said item owned by said player which is stored in said item obtaining and storing means (115, Steps P2 through P5), said request being sent from said user terminal (103, 104);
selling information producing and sending means (115, Step P105) for producing exhibition information showing selling of said item which is stored in said item obtaining and storing means (115) on the basis of said received selling request of item (Step A101, A103) and for sending said information to the other user terminal;
purchase request receiving means (115) for receiving through said Internet (100) said purchase request in connection with said item shown in said exhibition information, which is sent from said other user terminal (103, 104);
condition judgment means (115, Step P107) for comparing a purchase condition shown in said purchase request and a selling condition shown in said selling request with each other and for judging whether or not said purchase condition meets said selling condition;
item control means (115, Step P109) for deleting said item obtained by said player who has sent said selling request if a judgment is that said purchase condition meets said selling condition, and for rewriting and updating said deleted item as said item of said player who sent said purchase request; and
owned money control means for adding a selling amount of money of said item which was rewritten and updated to said owned amount of money of said player who sent said selling request which is stored in said owned money storing means (115, 241), and for subtracting said selling amount of money of said item from said owned amount of money of said player who sent said purchase request.

An other aspect of the invention is the machine for providing and controlling game, further comprising:
payment request receiving means (106) for receiving a payment request (C101, C103) which is sent from said user terminal (103, 104); and
money settlement means (106, Step P102) for executing a predetermined settlement procedure in connection with said payment amount of money shown in said payment request with said player who sent said payment request according to said received payment request (C101, C103),
wherein said owned money control means (115) adds said payment amount of money which was settled to said owned amount of money of said player who sent said payment request which is stored in said owned money storing means (Step P103).

An other aspect of the invention is the machine for providing and controlling game, further comprising:
drawing request receiving means (106) for receiving a request of drawing money which is sent from said user terminal (103, 104); and
remittance means for remitting an amount of money shown in said request of drawing money to an account of said player who sent said request of drawing money according to said received request of drawing money;
wherein said owned money control means (115) subtracts said money which was remitted from said owned money of said player who sent said request of drawing money which is stored in said owned money storing means (Step P208).

An other aspect of the invention is the machine for providing and controlling game, further comprising:
contribution information receiving means (115) for receiving contribution information showing whether or not said selling amount of money is to be contributed which is sent from said user terminal (103, 104); and
contribution information storing means (115, 241) for storing said received contribution information in a predetermined memory contribution flag of player control table);
wherein said owned money control means (115) has contribution money sending means (115, Step P204) for sending contribution money information showing that at least a part of said selling amount of money is contribution money if said contribution information is one showing affirmation of contribution by referring to said contribution information of said contribution information storing means (115, 241); and
said owned money control means (115) adds at least a part of said selling amount of money to said owned amount of money of said player who sent said selling request in said owned money storing means (115, 241) if said contribution information is one showing denying of contribution by referring to said contribution information of said contribution information storing means (115, 241) (Step P203).

### EFFECT OF INVENTION

According to the invention, item transactions between players by exchange of money and a procedure of moving money between players can be executed within the machine for providing and controlling game without players who actually trade.

Therefore, it is possible to construct a network system in which item transaction with exchange of money having high credibility is possible.

### BRIEF DESCRIPTION OF DRAWINGS

FIG. 1 is a structural diagram of a system which shows one embodiment of the invention.

FIG. 2 is a block diagram which shows a structure of a video game machine.

FIG. 3 is a block diagram which shows a structure of a server.

FIG. 4 is a conceptual diagram which shows a structure of a player control table.

FIG. 5 is a flowchart which shows processing routines at a time of downloading of game program in the present embodiment.

FIG. 6 is a flowchart which shows processing routines at a time of auction in the present embodiment.

FIG. 7 is a flowchart which shows processing routines for updating actual money.

### BEST MODE FOR CARRYING OUT THE INVENTION

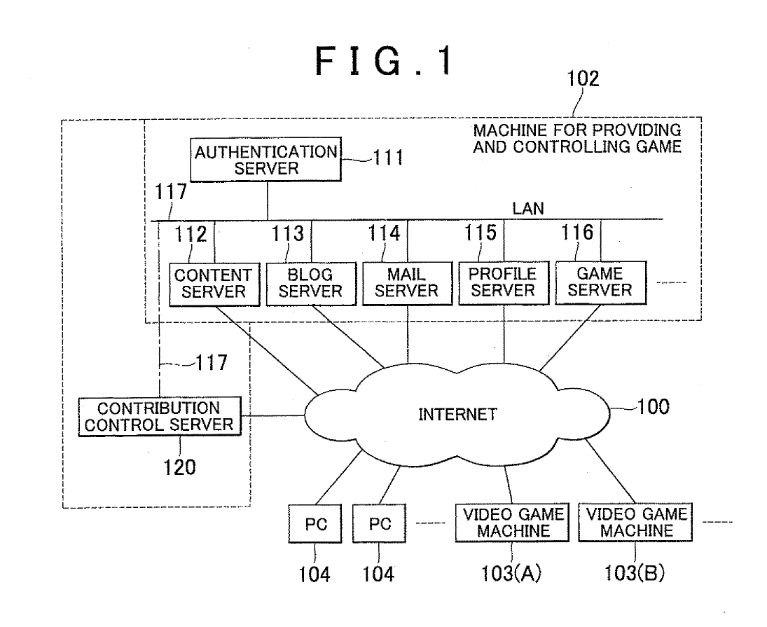

An embodiment of the invention is now explained, referring to appended figures. FIG. 1 is a conceptual diagram which shows a structure of a network game system through which a network video game service can be provided. In such a system, two or more video game machines 103(A), (B) . . . , and general purpose personal computers (“the PC” herein after) 104, . . . , and a contribution control server 102 are connected with a machine for providing and controlling game 102 via the Internet 100.

The machine for providing and controlling game 102 includes an authentication server 111 for controlling accounts for user authentication, a content server 112 for providing reading service of contents, such as voices and moving pictures as well as for providing an interface between the video game machines 103, . . . , and the other servers, a blog server 113 for providing blog environments, a mail server 114 for providing e-mail service, a profile server 115 for controlling a profile of a user and a game server 116 for providing game program. These servers 111 through 116 are reciprocally connected via LAN 117.

An user can obtain one's own authentication by accessing the authentication server 1 in the machine for providing and controlling game 102 through the Internet 100 with an user terminal, such as the video game machine 103 and the PC 104. The machine for providing and controlling game 102 sends a menu screen to a client who obtained an authentication. The video game machine 103 or the PC 104 is connected with the server according to each service by selecting each service which is displayed on the menu screen, so that the user can receive various kinds of information services.

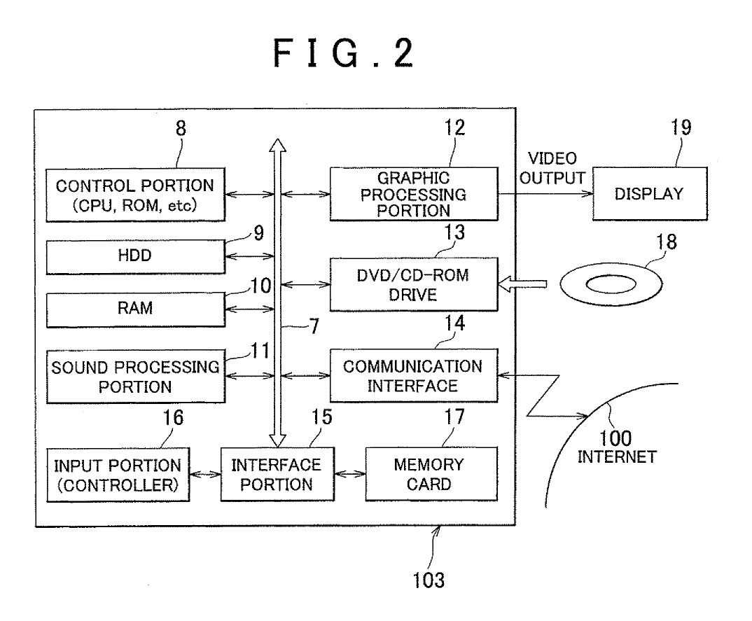

FIG. 2 is a block diagram which shows a structure of the video game machine 103 as a client terminal. As shown in the figure, such a video game machine 103 has a control portion 8, a HDD (Hard Disk), a RAM (Random Access Memory) 10, a sound processing portion 11, a graphic processing portion 12, a DVD/CD-ROM drive 13, a communication interface 14 and an interface portion 15 which are reciprocally connected via a bus 7.

The control portion 8 is comprised of a CPU (Central Processing Unit) and ROM (Read Only Memory) and the like, and executes programs developed in the RAM 10 in order on the basis of basic programs, such as booting program and an OS (Operating System) stored in the ROM so as to execute procedures for game proceeding. The control portion 8 controls operations in respective portions inside the game machine body. And, the HDD 9 stores game programs and data which are taken from the outside through the communication interface 14 and the Internet 100.

The RAM 10 is also used as a main memory on a game, and stores program and data which are necessary for game proceeding, which are transferred from a DVD/CD-ROM 18. The RAM 10 is also used as a work area at the time of executing program. The sound processing portion 11 processes for replaying sound data, such as BGM (Back Ground Music) or effective sounds, according to a game proceeding state in response to an instruction from the control portion 8, and outputs as sound signals.

The graphic processing portion 12 executes three-dimensional graphic processing in response to an instruction from the control portion 8 so as to produce image data according to a processing state of a game. And, the graphic processing portion 12 adds a predetermined synchronizing signal to the produced image data so as to output to a display 19 as a video signal.

The DVD/CD-ROM drive 13 drives the DVD/CD-ROM 18 which is set on the game machine body in response to an instruction from the control portion 8 so as to transfer the program and data which are stored in the DVD/CD-ROM 18 to the RAM 10 via the bus 7. The communication interface 14 is connected with the outside Internet 100 through a communication line, and executes a processing for exchange of program and data with the outside Internet 100 in response to an instruction from the control portion 8.

An input portion (controller) 16 which is attachable and detachable and a memory card 17 are connected with the interface portion 15. This interface portion 15 controls exchange of data between the input portion (controller) 16, the memory card 17, the control portion 8 and the RAM 10. The input portion (controller) 16 has various kinds of keys and buttons. By operating these keys and buttons, an instruction to move and an instruction to act to one's own character which are necessary for a game proceeding are inputted. And, the memory card 17 saves data which show a game proceeding state or a result of the game.

The DVD/CD-ROM 18 stores programs and data (game program or program which is shown in a flowchart described herein after) which are necessary for a game proceeding. The DVD/CD-ROM 18 is driven by the DVD/CDROM drive 13 so as to read out the stored program and data. The program and data which were read out of the DVD/CDROM 18 are transferred from the DVD/CD-ROM drive 13 to the RAM 10 through the bus 7.

The display 19 has a display screen which is a CRT (Cathode Ray Tube) for displaying an image corresponding to a video signal from the graphic processing portion 12. In general, a television receiver is used as the display 19.

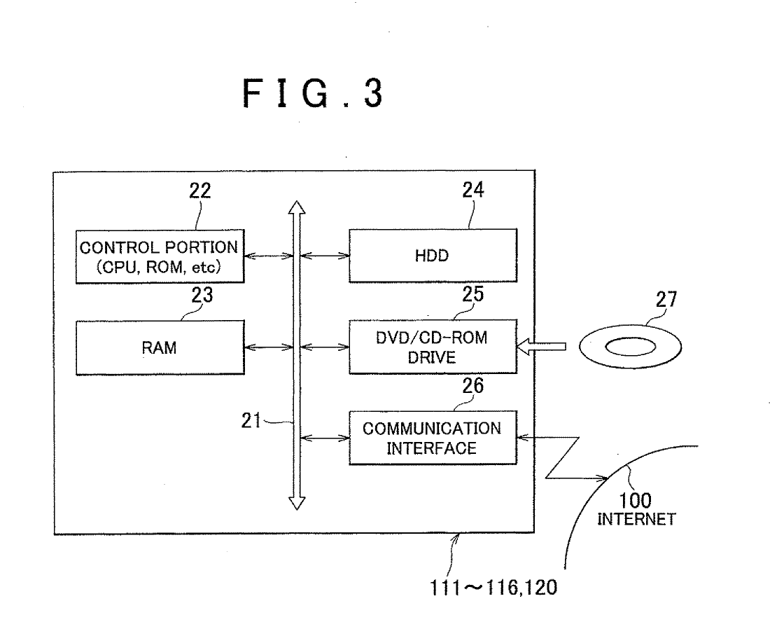

FIG. 3 is a block diagram which shows a structure of respective servers 111 to 116 which comprise the machine for providing and controlling game 102 and the contribution control server 120. As shown in the figure, the servers 111 to 116, and 120 has a control portion 22, a RAM 23, a HDD 24, a DVD-CD-ROM 25 and a communication interface 26 which are reciprocally connected through a bus 21.

The control portion 22 is comprised of a CPU and a ROM and the like, and executes programs stored in the RAM 23 in order on the basis of basic programs, such as booting program and an OS (Operating System) stored in the ROM so as to execute processes necessary as each server and processes shown in the flowchart described herein after. The control portion 22 controls operations of respective portions of the server. The RAM 23 is used as a main memory on the game, and stores program and data necessary for a game proceeding which are transferred from a DVD/CD-ROM 27. The RAM 23 is also used as a work area at the time of executing the program.

The HDD 24 stores data which are taken from the outside through the communication interface 26 and the Internet 100. The DVD/CD-ROM drive 25 drives the DVD/CD-ROM 27 which is set on the server in response to an instruction from the control portion 22 so as to transfer the program and data which are stored in the DVD/CD-ROM 27 to the RAM 23 through the bus 21.

The communication interface 26 is connected with the outside Internet 100 through a communication line, and executes a processing for exchange of program and data with the outside Internet 100 in response to an instruction from the control portion 22.

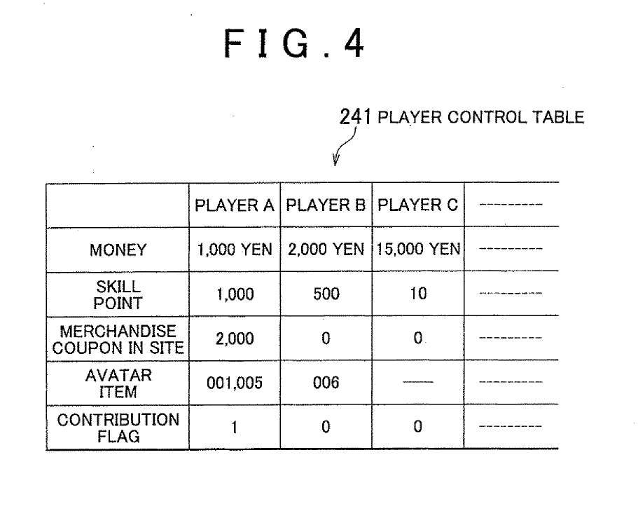

The HDD 24 of the game server 116 stores two or more kinds of game programs. And, the HDD 24 of the profile server 115 is provided with a player control table 241 as shown in FIG. 4.

Such a player control table 241 stores “money” amount which each player owns in a site, that is, holding amount of money of each player which is usable in the game, an accumulation value of “skill points” which the player obtains by the game, an amount of “merchandise coupon in site” which is usable only in the site, a code which shows a kind of “avatar item” owned, and a state of “contribution flag”, corresponding to a proper TD which shows Player A, Player B, Player C, or . . . . Such a “contribution flag” is zero (0) at a usual state, and is set on one (1) when the player contributes an amount of an article which is sold in an auction described herein after.

The avatar item is the item which is usable in a blog. And, the contribution control server 120 is one controlled by volunteer group or association, such as UNICEF, and an amount of money contributed (accumulation value) is stored in the HDD 24. In another structure, the contribution control server 120 may be constructed so as to connect with the other servers 111 to 116 through the LAN 117 as the server comprising the machine for providing and controlling game 102 as shown in FIG. 1, and contribution actions at the time of item selling by the player may be controlled by the machine for providing and controlling game 102 so that a stream of money received or given in the item transaction by the players can be collectively controlled in order to improve a credibility of the whole system.

In the embodiment having the above-mentioned structure, the control portion 8 secures an area for storing information in the RAM 10 when a power is on at the video game machine 103, and a program area, a data area, a work area and the like are secured in the RAM 10, thereby. The player who owns the video game machine 103 starts the communication interface 14, and accesses the machine for providing and controlling game 102 which is a desirable site through a communication line (not shown) and the Internet 100. By doing so, a menu screen is displayed on the display 19 of the video game machine 103.

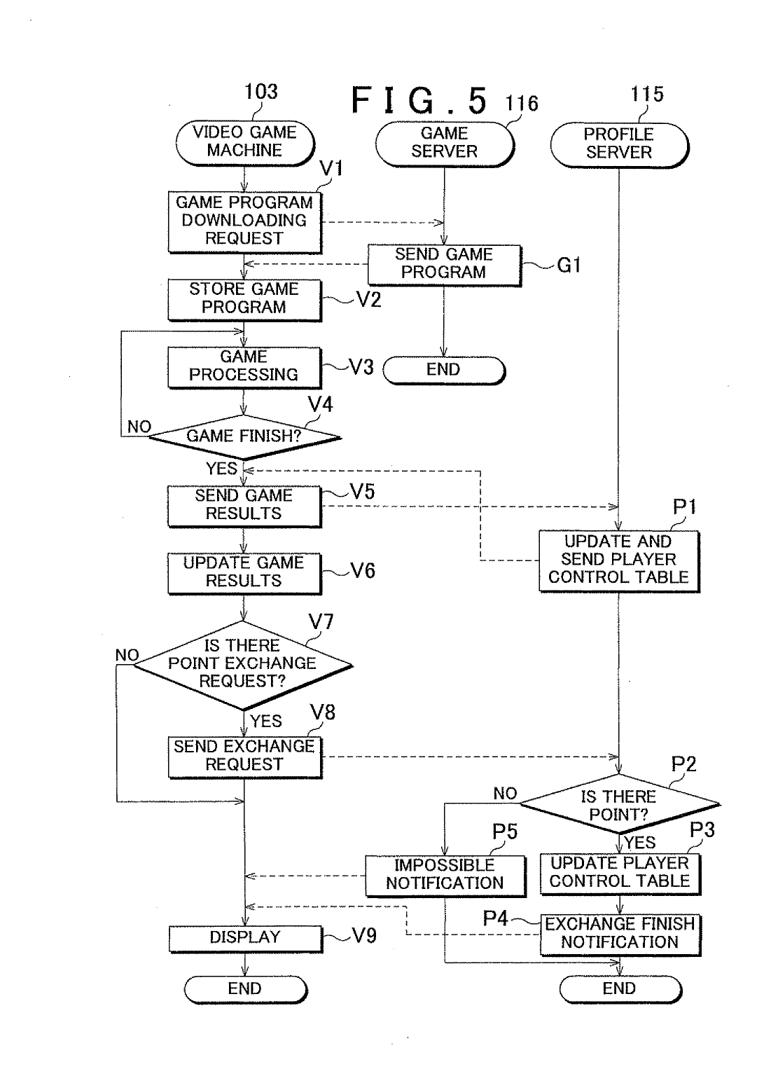

When the player operates a downloading request of a desired game program on the menu screen through the input portion (controller) 16, the video game machine 103 sends the downloading request of the game program which is designated by the game server 116 as shown in a flowchart in FIG. 5 (Step V1).

The game server 116 receives the downloading request of this game program, and reads the designated game program out of the HDD 24, and sends the read program to the video game machine 103 (Step G1). The video game machine 103 receives the sent game program so as to store in the HDD 9 (Step V2). Then, with the video game machine 103, the player can enjoy the designated game.

If the player operates the input portion (controller) 16 in the above-mentioned state, game processing is executed according to the program stored in the HDD 9 in Step V2 (Step V2) and the player can enjoy the game. When the player who enjoyed the game in this way operates a game finish though the input portion (controller) 16 for finishing the game, a judgment of Step V4 becomes YES, and the program proceed to Step V5 from Step V4. And, acquisition point which was obtained in the game, such as a skill point, is sent to the machine for providing and controlling game 102 as game results as well as the player's ID (Step V6).

Then, the profile server 115 of the machine for providing and controlling game 102 receives the acquisition point, such as the skill point, which was sent from the vide game machine 103 as the game results as well as the player's ID. And, in the player control table 241, a value of the skill point which was received at this time is added to the value of the skill point of the player so as to update the value, and the updated data is sent to the video game machine 103 (Step P1). The video game machine 103 stores the value of the acquisition point, which is sent data, such as the skill point, in the memory card 17 as the game results and updates contents of the memory (Step V6).

Then, the game results, such as the skill point, are controlled by the player control table 241 on the profile server 115 side, and the control results are transferred in Step P1, and are stored in the memory card 17 of the video game machine 103, being updated. Even if users alter data of the memory card 17 for a purpose of unfairly obtaining benefits, the data are updated into correct data (game results, such as correct skill point) by the data update in Step V6, so that unfairly obtaining of benefits by users can be prevented.

At this time, the skill point is the game result and may be different value, depending on an ability or a skill of the player in the game. Therefore, the value of the skill point of the player who is good at the game and can obtain many skill points in the player control table 241 widely increases. But, the value of the skill point of the player who is not good at the game and only obtains low skill points in the player control table 241 slightly increases only. Then, the value of the skill point in the player control table 241 is different due to the game skill of the player, as shown in FIG. 4.

The video game machine 103 judges whether or not there is a point exchange request of exchanging the obtained skill point for a merchandise coupon in site or an avatar item, that is, an item purchase request by an operation of the input portion (controller) 16 by the player (Step V7). If there is the point exchange request, the merchandise coupon in site or the kind of the avatar item which purchase was designated by the item purchase request which was outputted by the operation of the input portion (controller) 16 is sent to the machine for providing and controlling game 102 as well as the player's ID (Step V8).

Then, the profile server 115 of the machine for providing and controlling game 102 receives the amount of the merchandise coupon in site or the kind of the avatar item which was requested together with the player's ID. Thereafter, whether or not there is the skill point of the player which is exchangeable for the amount of the merchandise coupon in site or the kind of the avatar item, having the amount which is required for exchange (purchase) in the player control table 241 is judged (Step P2).

That is, in connection with merchandise coupons, an amount of the merchandise coupon which is exchangeable for one (1) point of the skill point is stored in a predetermined memory, such as the HDD 24. In case where the merchandise coupon is exchangeable for one (1) point of the skill point, the skill point which is necessary for exchange of the merchandise coupon is one (1) point. In the merchandise coupon having a predetermined amount, a number of the skill point which is necessary for the merchandise coupon is stored in the memory. In the avatar item, the value of the skill point which is necessary for exchange according to its kind is stored in the HDD 24 (memory) of the profile server 115 in advance. Therefore, the profile server 115 can judge whether or not the player has the skill point necessary for exchange on the basis of this information stored in the HDD 24, the amount of the merchandise coupon in site which was required for exchange or the kind of the avatar item and the present value of the skill point of the player in the player control table 241.

If the player has the skill point for exchange, the player executes an item acquisition procedure. At first, a procedure for updating the player control table is executed (Step P3). That is, the amount of “merchandise coupon in site” of the player is increased according to the amount of the merchandise coupon in site which was required, or a code showing the kind of the required avatar item is written in a section of “avatar item” in the player control table 241. And, the skill point of the player which corresponds to the increased amount of the merchandise coupon in site or the kind of the avatar item of the code written in is reduced so as to update the player control table 241. Thereafter, a notice of exchange finish is sent (Step P4).

If the judgment in Step P2 is NO and there is no skill point which is sufficient for exchange according to the request, a notice of impossibility is sent (Step P5). Then, the video game machine 103 received the notice of impossibility or the notice of exchange finish so as to display this notice on the display 19 (Step V9). Then, the player can confirm as to whether or not the requested exchange of the skill point is possible.

So, the player who has an excellent game skill and acquired many skill points can obtain the merchandise coupon in site or the avatar item by the exchange for the skill point. But, the player who is poor in the game skill and cannot obtain many skill points, can not obtain the merchandise coupon in site or the avatar item.

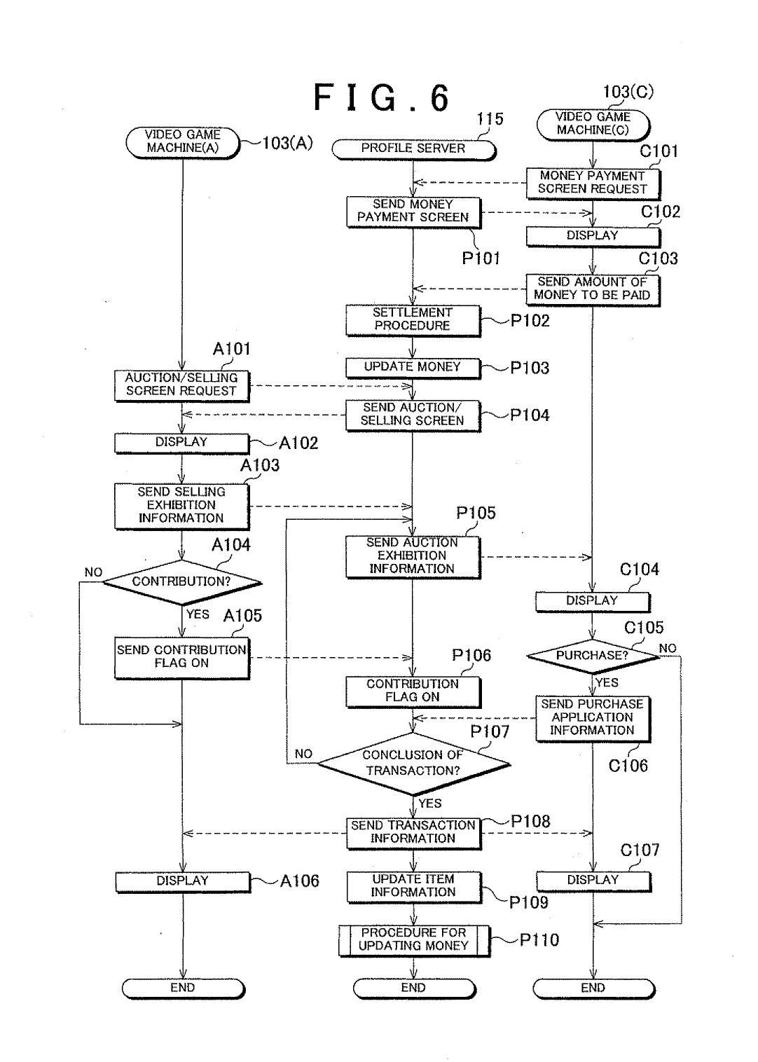

Such a player who is poor in the game skill and is difficult to obtain the skill point, Player C for instance, can purchase the item and the like with actual money. That is, firstly the player accesses the machine for providing and controlling game 102, and selects “payment” through an operation of the input portion (controller) 16 in such a state that the menu screen is displayed. Then, a request of money payment screen is sent from the video game machine 103 (C) as shown in the flowchart of FIG. 6 (Step C101).

The profile server 115 receives this money payment screen request and sends the money payment screen (Step P101). The video game machine 103 (c) receives this and displays the money payment screen on the display 19 (Step C102). Thereafter, Player C writes the amount of money to be paid on the money payment screen for sending. Then, the video game machine 103 (C) sends the payment amount written in (Step C103).

The profile server 115 received this payment amount which was sent and executes a settlement procedure (Step P102). For such a settlement procedure, a well-known settlement method may be used. Money may be drawn from a bank account of the player on the basis of a credit card number which is registered in advance. Alternatively, if the player buys a predetermined amount of a pre-paid card at a retail store and sends a number of this pre-paid card in Step C103, money may be drawn from an account of a person who controls the pre-paid card. Subsequently, the amount of money which has been settled is added to the section of “money” of the player in the player control table 241 so as to update the money of the player, that is, the amount of owned money which can be used in the game (Step P103).

On the other hand, the player who has an excellent game skill and many skill points, such as Player A, obtains many merchandise coupons in site or the avatar items by exchange of the skill points. Then, such a player can obtain earnings by selling the merchandise coupon in site or the avatar item which has obtained. That is, the player firstly accesses the machine for providing and controlling game 102, and selects “auction/selling” through the operation of the input portion (controller) 16 in such a state that the menu screen is displayed. Then, an auction/selling screen request is sent from the video game machine 103 (A) (Step A1011.

The profile server 115 received this auction/selling screen request and sends the auction/selling screen (Step P104). The video game machine 103 (A) receives this screen and displays the auction/selling screen on the display 19 (Step A102). If Player A writes the amount of the merchandise coupon in site to be selled or the kind of the avatar item in this auction/selling screen and executes a sending operation, the video game machine 103(c) sends selling exhibition information which was written in (Step A103).

If a subject for selling at this time is the avatar item and the avatar item has no fixed price, the lowest bid price which is set by Player A or a designated bid price is sent, being included in the selling exhibition information.

Subsequently, whether or not there was the contribution instruction is judged (Step A104). This contribution instruction is an operation for representing such a player's intension that he (she) contributes an income due to a conclusion of selling of the merchandise coupon in site having the amount of the goods to be sold by Player A or the avatar item without obtaining as own benefits. And, the video game machine 103(A) judges that there was a contribution instruction (YES) if a predetermined operation was executed in the input portion (controller) 16, and judges that there was no contribution instruction (NO) if no operation was executed. In case where the judgment is that there was the contribution instruction, a contribution flag ON signal is sent to the profile server 115 (Step A105).

On the other hand, the profile server 115 receives the selling exhibition information which was sent in Step A103 and produces auction exhibition information on the basis of the information and sends the produced information to the video game machine 103 (C), the other video game machine or the PC 104 (Step P105). If the contribution flag ON signal is sent by the procedure in Step A105, the contribution flag of the player is made ON in the player control table 241 which is stored in the memory (Step P106). If the contribution flag ON signal is sent from the video game machine 103 (A) of Player A as the present embodiment, the contribution flag of Player A is set on ON (1) in the player control table 241, as shown in FIG. 4.

The auction exhibition information which is sent by the procedure in Step P105 includes the amount of the merchandise coupon which is exhibited and the kind or the price (such as the lowest bid price and the fixed price) of the avatar item. The video game machine 103(C) received and displayed this on the display 19 (Step C104).

If the player who watches the auction exhibition information which is displayed on the display 19 writes the amount of the merchandise coupon in site which is a subject or purchase, the kind of the avatar item, or the bid price (if necessary) in order to buy some exhibition and instructs to send it, the judgment of Step C 105 becomes YES. Then, the program proceeds from Step C105 to Step C106, and a purchase application information in which the amount of the merchandise coupon in site which is a subject for purchase, or the kind of the avatar item, or the bid price (if necessary) is written is sent (Step C106).

The profile server 115 receives the purchase application information which was sent and judges whether or not the transaction was concluded (Step P107). That is, whether or not the purchase condition meets the selling condition, and whether or not money the same as the purchase price or more remains in the section of “money” of Player C who is the purchase application person in the player control table 241 is judged. In this Step P107, the judgment is NO if the purchase condition does not meet the selling condition, or money the same as the purchase price or more does not remain in the section of “money” of Player C who is the purchase application person in the player control table 241 even if the purchase condition meets the selling condition. And, the judgment is YES if the purchase condition meets the selling condition and the money the same as the purchase price or more remains in the section of “money” of Player C who is the purchase application person in the player control table 241.

If the judgment in Step P107 is YES and the transaction is concluded, each transaction conclusion information is sent to the video game machines 103 (A) and (C) of Players A and C. Each video game machine (A) or (C) receives this transaction conclusion information, and displays this information on the display 19 (Step A106, Step C107). This transaction conclusion information includes information, such as conclusion date or conclusion price of the transaction, a subject item, and respective players A and C can confirm the transaction conclusion information.

Subsequently, the profile server 115 executes a procedure for updating item information (Step P109). In the procedure for updating item information, a procedure for rewiring and updating is executed in such a manner that the amount of “merchandise coupon in site” of Player C who sold is subtracted or the code of the section of “avatar item” is deleted, and the amount of “merchandise coupon in site” of Player A who purchased is increased or the code of the section of “avatar item” is added in the player control table 241. Furthermore, the profile server 115 executes a procedure for updating money (Step P110).

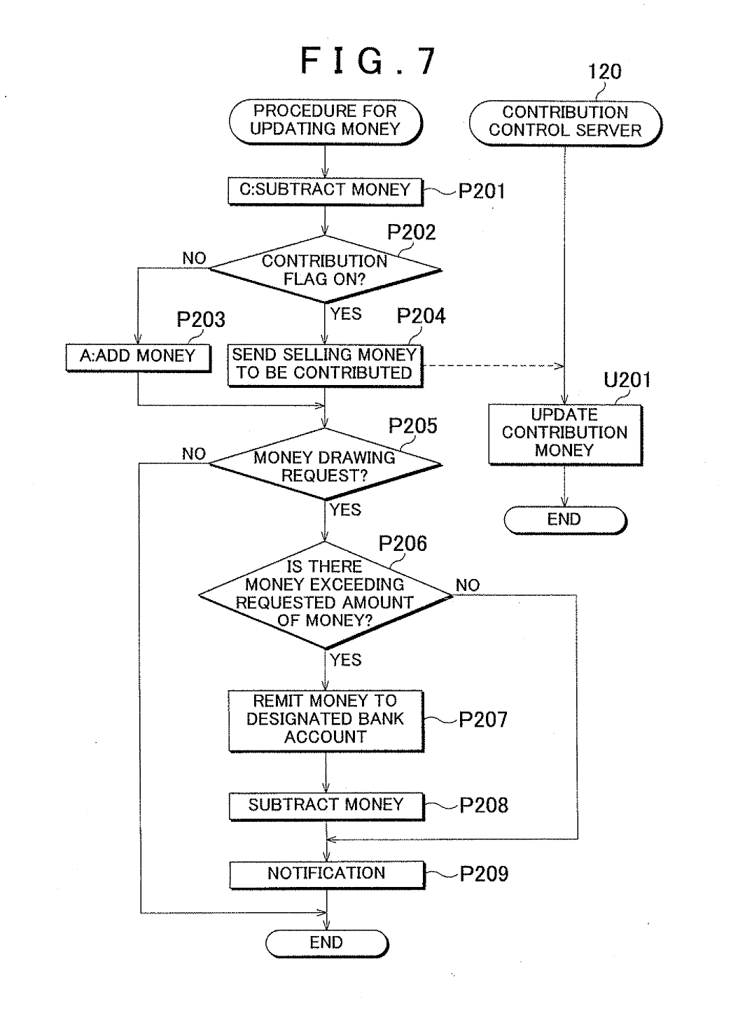

FIG. 7 is a flowchart showing details of the procedure for updating money (Step P110). Firstly, the purchase amount of money, that is, money corresponding to the transaction amount is subtracted from “money” of Player C who purchased in the player control table 241 so as to be updated (Step P201). Thereafter, whether or not the contribution flag of Player A who is a seller is ON (1) in the player control table 241 is judged (Step P202).

If at the result of the judgment in Step P202, the contribution flag of Player A is not ON (1) but OFF (0) and Player A intends to obtain the selling amount of money as own benefits without contributing (including such a case where a part of the selling amount is own benefits), the selling amount of money, that is, the amount of money corresponding to the selling price (or a part thereof) is added to “money” of Player A who sold so as to be updated (Step P203).

Then, the machine for providing and controlling game 102 having the profile server 115 with the player control table 241 collectively controls the transaction of items on the basis of the results of the game and the exchange of money through the transaction of items. By such a collective control of money by the machine for providing and controlling game 102, it is possible to provide the network system wherein the credibility of the transaction can be fully secured and the transaction on the game by exchange of money having high credibility is possible.

If the contribution flag of Player A is ON (1) and Player A intends to contribute selling amount of money at the result of the judgment in Step P202, the amount of money corresponding to the received money (selling amount of money, purchase money) is sent to the contribution control server 120 as contribution money information (Step P204). The contribution control server 120 receives such contribution money information, and adds the amount of money which is shown in the contribution money information to the present contribution money as the contribution money from the player so as to be updated (Step U201). The contribution money from the player is not all of the selling amount of money, but may be money corresponding to some contribution rate which is instructed to the machine for providing and controlling game 102 through the operation of the input means, such as the game machine 103 or the PC 104, by the player.

Therefore, it is possible to automatically contribute money at the time of conclusion of the transaction of items if the player only clearly expresses his (her) intension of contribution of benefits obtained by an auction in advance. Then, the results by the video game can be reflected in social contribution, and it is possible to improve a social position of the video game and to improve a recreational image on the video game.

The “money” which is controlled by the player control table 241 can be properly drawn in each player so as to use with an usual money use form.

That is, the profile server 115 judges whether or not there was a money drawing request from any of the video game machine 103 or the PC 104 (Step P205). If there was the money drawing request, whether or not the amount which is the same as or more than the requested amount of money is stored in the section of “money” of the player control table 241 is judged (Step P206). If the amount of money which is the same as or more than the requested money is not stored (Step P206: NO), the program proceeds to Step P209, and a notification showing remittance is impossible since the requested exceeds remaining money is sent to the corresponding video game machine 103 or the PC 104.

If the amount of money which is the same as or more than the requested money is stored (Step P206: YES), the requested amount of money is remitted to a bank account of the player which has already been designated (Step P207). Therefore, the player can draw money from the bank account and freely use the money. The player having an excellent game skill can use money corresponding to the results obtained by the game.

Subsequently, the profile server 115 subtracts remittance amount of money from “money” of the player in the player control table 241 and update the amount (Step P208). And, such a remittance notification, that is, the notification showing remittance amount, remittance date, remaining amount of money and the like, is sent to the corresponding video game machine 103 or the PC 104 (Step P209). By doing so, the remittance notification is displayed on the display 19 of the corresponding video game machine 103 or the PC 104 so that the player can confirm the remittance.

In the present embodiment, money is added in Step 203 without subtracting a handling fee, but money may be added, subtracting a predetermined rate of a handling fee from the selling amount of money. Besides, money is subtracted without adding a handling fee to the selling amount of money in Step 201, but money may be subtracted, adding a predetermined rate of the handling fee to the selling amount of money.

Then, it is possible to construct such a business model that a dealer for providing and controlling the game who manages the machine for proving and controlling game 102 can obtain benefits also. And, the avatar item usable in a blog is shown as the item in the present embodiment, but another item usable on the game is available.

In the present embodiment, the video game machine 103 and the display 19 are separately provided, but a unit of both is also available. And, the display 19 may have two or more image display portions, such as an upper and lower image displaying portions. The present embodiment mentioned above refers to the video game machine 103, but various kinds of machines or apparatuses, such as portable phone terminals, portable game machines, can be applied to the invention as long as they have a function of producing images and a function of the Internet connection.

1. A machine for providing and controlling game (102) with which two or more user terminals (103, 104) can be connected through the Internet (100), a game provided from said machine can be executed by a player through said user terminal (103, 104) so as to obtain points as the result of execution of said game and to store said obtained points therein, comprising:
point receiving means (112) for receiving through said Internet (100) a value of a point which said player obtained by an execution of said game, which is sent from said user terminal;
point storing means (112, 241, Step P1) for accumulating and storing said received value of point for each said player;
an item file (24, 115) for storing items (such as merchandise coupons and avatar items) which said player can obtain by said point and point numbers necessary for such an exchange in advance;
purchase request receiving means (115) for receiving through said Internet (100) an item purchase request (Step V8) for each said player which is sent from said user terminal;
item obtaining and storing means (115, Steps P2 to P5) for executing a predetermined obtaining processing on the basis of said point stored in said point storing means (112, 241) for said item stored in said item file according to said received item purchase request and for storing said obtained item for each said player;
owned money storing means (115, 241) for storing owned amount of money which each player has, which is usable in a game world every each said player;
selling request receiving means (115) for receiving through said Internet (100) selling request (Step A101, A103) of said item owned by said player which is stored in said item obtaining and storing means (115, Steps P2 through P5), said request being sent from said user terminal (103, 104);
selling information producing and sending means (115, Step P105) for producing exhibition information showing selling of said item which is stored in said item obtaining and storing means (115) on the basis of said received selling request of item (Step A101, A103) and for sending said information to the other user terminal;
purchase request receiving means (115) for receiving through said Internet (100) said purchase request in connection with said item shown in said exhibition information, which is sent from said other user terminal (103, 104);
condition judgment means (115, Step P107) for comparing a purchase condition shown in said purchase request and a selling condition shown in said selling request with each other and for judging whether or not said purchase condition meets said selling condition;
item control means (115, Step P109) for deleting said item obtained by said player who has sent said selling request if a judgment is that said purchase condition meets said selling condition, and for rewriting and updating said deleted item as said item of said player who sent said purchase request; and
owned money control means for adding a selling amount of money of said item which was rewritten and updated to said owned amount of money of said player who sent said selling request which is stored in said owned money storing means (115, 241), and for subtracting said selling amount of money of said item from said owned amount of money of said player who sent said purchase request.

2. The machine for providing and controlling game according to claim 1, further comprising:
payment request receiving means (106) for receiving a payment request (C101, C103) which is sent from said user terminal (103, 104); and
money settlement means (106, Step P102) for executing a predetermined settlement procedure in connection with said payment amount of money shown in said payment request with said player who sent said payment request according to said received payment request (C101, C103),
wherein said owned money control means (115) adds said payment amount of money which was settled to said owned amount of money of said player who sent said payment request which is stored in said owned money storing means (Step P103).

3. The machine for providing and controlling game according to claim 1, further comprising:
drawing request receiving means (106) for receiving a request of drawing money which is sent from said user terminal (103, 104); and
remittance means for remitting an amount of money shown in said request of drawing money to an account of said player who sent said request of drawing money according to said received request of drawing money;
wherein said owned money control means (115) subtracts said money which was remitted from said owned money of said player who sent said request of drawing money which is stored in said owned money storing means (Step P208).

4. The machine for providing and controlling game according to claim 1, further comprising:
contribution information receiving means (115) for receiving contribution information showing whether or not said selling amount of money is to be contributed which is sent from said user terminal (103, 104); and
contribution information storing means (115, 241) for storing said received contribution information in a predetermined memory (contribution flag of player control table);
wherein said owned money control means (115) has contribution money sending means (115, Step P204) for sending contribution money information showing that at least a part of said selling amount of money is contribution money if said contribution information is one showing affirmation of contribution by referring to said contribution information of said contribution information storing means (115, 241); and
said owned money control means (115) adds at least a part of said selling amount of money to said owned amount of money of said player who sent said selling request in said owned money storing means (115, 241) if said contribution information is one showing denying of contribution by referring to said contribution information of said contribution information storing means (115, 241) (Step P203).
